(19) United States
(12) Patent Application Publication
(10) Pub. No.: US 2013/0329964 A1
(43) Pub. Date: Dec. 12, 2013

(54) IMAGE-PROCESSING DEVICE AND IMAGE-PROCESSING PROGRAM

(71) Applicant: Takeshi Nishi, Yokohama-shi (JP)

(72) Inventor: Takeshi Nishi, Yokohama-shi (JP)

(73) Assignee: NIKON CORPORATION, Tokyo (JP)

(21) Appl. No.: 14/001,273

(22) PCT Filed: Mar. 2, 2012
(86) PCT No.: PCT/JP2012/055351

§ 371 Date: Aug. 23, 2013

(30) Foreign Application Priority Data
Mar. 4, 2011 (JP) 2011-047525

(51) Int. Cl. G06K 9/00

(52) U.S. Cl. CPC G06K 9/00362
USPC 382/110

(57) ABSTRACT

There are provided a face detection unit that detects a face of an animal in an image; a candidate area setting unit that sets an animal body candidate area for a body of the animal in the image based upon face detection results provided by the face detection unit; a reference image acquisition unit that obtains a reference image; a similarity calculation unit that divides the animal body candidate area having been set by the candidate area setting unit into a plurality of small areas and calculates a level of similarity between an image in each of the plurality of small areas and the reference image; and a body area estimating unit that estimates an animal body area corresponding to the body of the animal from the animal body candidate area based upon levels of similarity having been calculated for the plurality of small areas by the similarity calculation unit.

### TECHNICAL FIELD

The present invention relates to an image-processing device and an image-processing program.

### BACKGROUND ART

In a method known in the related art, the position taken by a human body, centered on a person's face and skin color, is determined and the attitude of the human body is then estimated by using a human body model (see patent literature 1).

### CITATION LIST

### Patent Literature

Patent literature 1: Japanese patent No. 4295799

### SUMMARY OF INVENTION

### Technical Problem

However, there is an issue to be addressed in the method in the related art described above, in that if skin color cannot be detected, the human body position detection capability will be greatly compromised.

### Solution to Problem

(1) An image-processing device according to a first aspect of the present invention comprises: a face detection unit that detects a face of an animal in an image; a candidate area setting unit that sets an animal body candidate area for a body of the animal in the image based upon face detection results provided by the face detection unit; a reference image acquisition unit that obtains a reference image; a similarity calculation unit that divides the animal body candidate area having been set by the candidate area setting unit into a plurality of small areas and calculates a level of similarity between an image in each of the plurality of small areas and the reference image; and a body area estimating unit that estimates an animal body area corresponding to the body of the animal from the animal body candidate area based upon levels of similarity having been calculated for the plurality of small areas by the similarity calculation unit.

(2) According to a second aspect of the present invention, in the image-processing device according to the first aspect, it is preferable that the candidate area setting unit sets the animal body candidate area in the image in correspondence to a size and a tilt of the face of the animal having been detected by the face detection unit.

(3) According to a third aspect of the present invention, in the image-processing device according to the first or second aspect, it is preferable that the face detection unit sets a rectangular frame depending on a size and a tilt of the face of the animal at a position of the face of the animal in the image; and the candidate area setting unit sets the animal body candidate area by placing a specific number of rectangular frames, each identical to the rectangular frame having been set by the face detection unit, next to one another.

(4) According to a fourth aspect of the present invention, in the image-processing device according to the third aspect, it is preferable that the similarity calculation unit defines the plurality of small areas by dividing each of the plurality of rectangular frames that forms the animal body candidate area into a plurality of areas.

(5) According to a fifth aspect of the present invention, in the image-processing device according to the fourth aspect, it is preferable that the reference image acquisition unit further sets second small areas each contained within one of the rectangular frames and having a size matching a size of the plurality of small areas, and obtains images in a plurality of second small areas so as to use each image as the reference image; and the similarity calculation unit calculates levels of similarity between images in the individual small areas and the image in each of the plurality of second small areas.

(6) According to a sixth aspect of the present invention, in the image-processing device according to the fifth aspect, it is preferable that the reference image acquisition unit sets each of the second small areas at a center of one of the rectangular frame.

(7) According to a seventh aspect of the present invention, in the image-processing device according to any one of the first through sixth aspects, it is preferable that the similarity calculation unit applies a greater weight to a level of similarity calculated for a small area, among the plurality of small areas set within the animal body candidate area, which is closer to the face of the animal having been detected by the face detection unit.

(8) According to an eighth aspect of the present invention, in the image-processing device according to any one of the first through seventh aspects, it is preferable that the similarity calculation unit calculates levels of similarity by comparing one of, or a plurality of parameters among luminance, frequency, edge component, chrominance and hue between the images in the small areas and the reference image.

(9) According to a ninth aspect of the present invention, in the image-processing device according to any one of the first through eighth aspects, it is preferable that the reference image acquisition unit uses an image stored in advance as the reference image.

(10) According to a tenth aspect of the present invention, in the image-processing device according to any one of the first through ninth aspects, it is preferable that the face detection unit detects a face of a person in an image as the face of the animal; the candidate area setting unit sets a human body candidate area for a body of the person in the image as the animal body candidate area based upon the face detection results provided by the face detection unit; the similarity calculation unit divides the human body candidate area having been set by the candidate area setting unit into a plurality of small areas and calculates levels of similarity between images in the plurality of small areas and the reference image; and the body area estimating unit estimates a body area corresponding to the body of the person, which is included in the human body candidate area, as the animal body area based upon the levels of similarity having been calculated for the plurality of small areas by the similarity calculation unit.

(11) According to an eleventh aspect of the present invention, in the image-processing device according to the tenth aspect, it is preferable that an upper body area corresponding to an upper half of the body of the person is estimated and then a lower body area corresponding to a lower half of the body of the person is estimated based upon estimation results obtained by estimating the upper body area.

(12) An image-processing device according to a twelfth aspect of the present invention comprises: a face detection unit that detects a face of an animal in an image; a candidate area setting unit that sets a candidate area for a body of the animal in the image based upon face detection results provided by the face detection means; a similarity calculation unit that sets a plurality of reference areas within the candidate area for the body having been set by the candidate area setting means and calculates levels of similarity between images within small areas defined within the candidate area and a reference image contained in each of the reference areas; and a body area estimating unit that estimates an animal body area corresponding to a body of the animal, which is included in the candidate area for the body, based upon the levels of similarity calculated for the small areas by the similarity calculation means.

(13) An image-processing program, according to a thirteenth aspect of the present invention, enables a computer to execute; face detection processing for detecting a face of an animal in an image; candidate area setting processing for setting an animal body candidate area for a body of the animal in the image based upon face detection results obtained through the face detection processing; reference image acquisition processing for obtaining a reference image; similarity calculation processing for dividing the animal body candidate area, having been set through the candidate area setting processing, into a plurality of small areas and calculating levels of similarity between images in the plurality of small areas and the reference image; and body area estimation processing for estimating an animal body area corresponding to a body of the animal, which is included in the animal body candidate area, based upon the levels of similarity having been calculated through the similarity calculation processing for the plurality of small areas.

### Advantageous Effect of the Invention

According to the present invention, the area taken up by an animal body can be estimated with great accuracy.

### BRIEF DESCRIPTION OF THE DRAWINGS

FIG. 1 is a block diagram showing the structure of the image-processing device achieved in a first embodiment.

FIG. 2 presents a flowchart of the processing executed based upon the image-processing program achieved in the first embodiment.

FIG. 3 presents an example of image processing that may be executed in the first embodiment.

FIG. 4 presents an example of image processing that may be executed in the first embodiment.

FIG. 5 presents an example of image processing that may be executed in the first embodiment.

FIG. 6 presents an example of image processing that may be executed in the first embodiment.

FIG. 7 presents an example of image processing that may be executed in the first embodiment.

FIG. 8 presents an example of image processing that may be executed in the first embodiment.

FIG. 9 presents an example of image processing that may be executed in the first embodiment.

FIG. 10 presents an example of image processing that may be executed in the first embodiment.

FIG. 11 shows a rectangular block set at a face position and rectangular blocks set next to one another over a human body candidate area.

FIG. 12 shows, as an example, a template Tp (0, 0) in an enlarged view of a rectangular block Bs (0, 0) (the rectangular block at the upper left corner).

FIG. 13 is a block diagram showing the structure adopted in a second embodiment.

FIG. 14 is a block diagram showing the structure adopted in a third embodiment.

FIG. 15 is a block diagram showing the structure adopted in a fourth embodiment.

FIG. 16 is a block diagram showing the structure adopted in a fifth embodiment.

FIG. 17 is a block diagram showing a structure pertaining to the fifth embodiment.

FIG. 18 is a block diagram showing a structure pertaining to the fifth embodiment.

FIG. 19 illustrates the overall configuration of a system used to provide a program product.

### DESCRIPTION OF EMBODIMENTS

### First Embodiment of the Present Invention

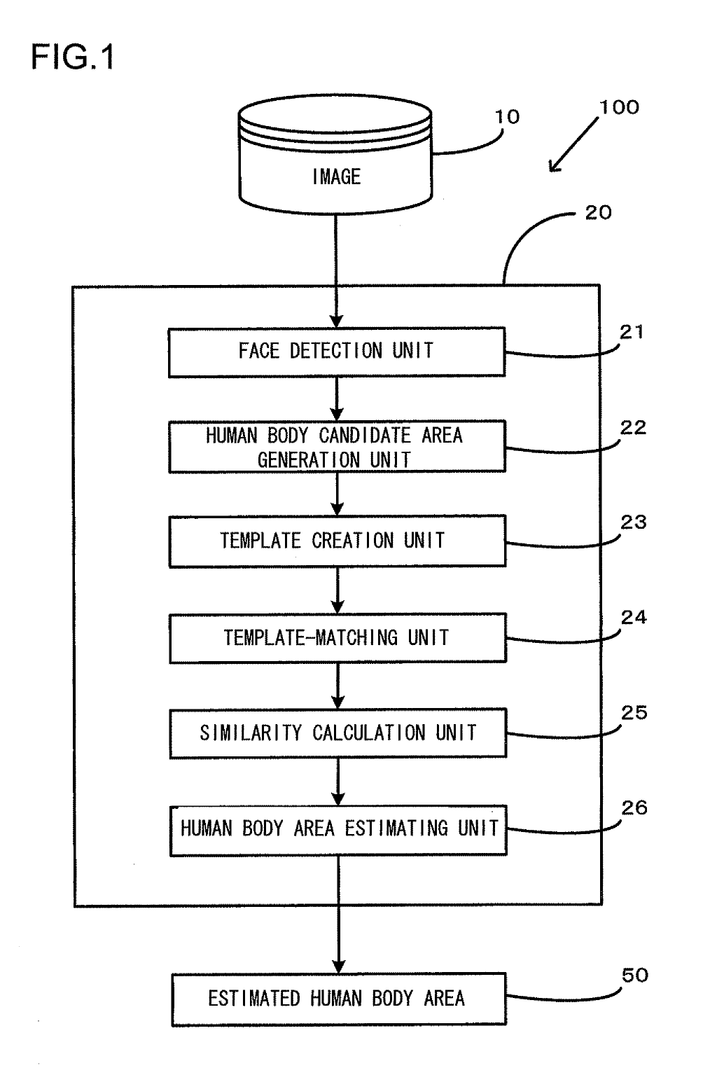

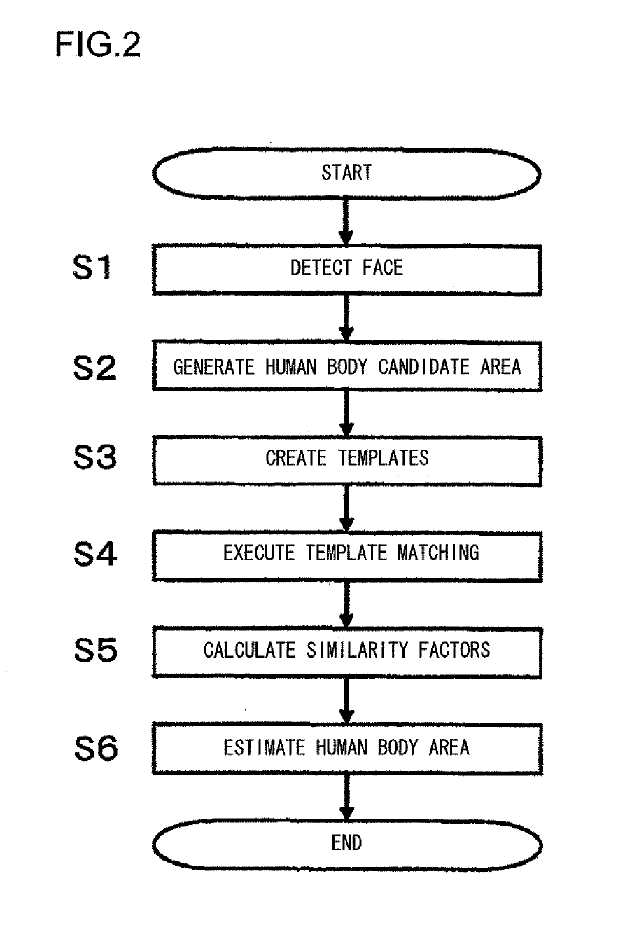

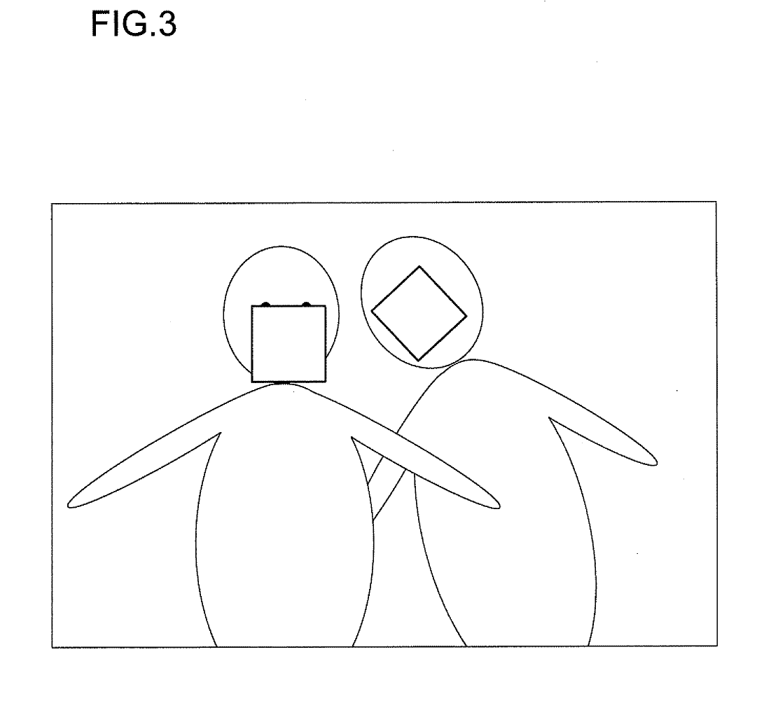

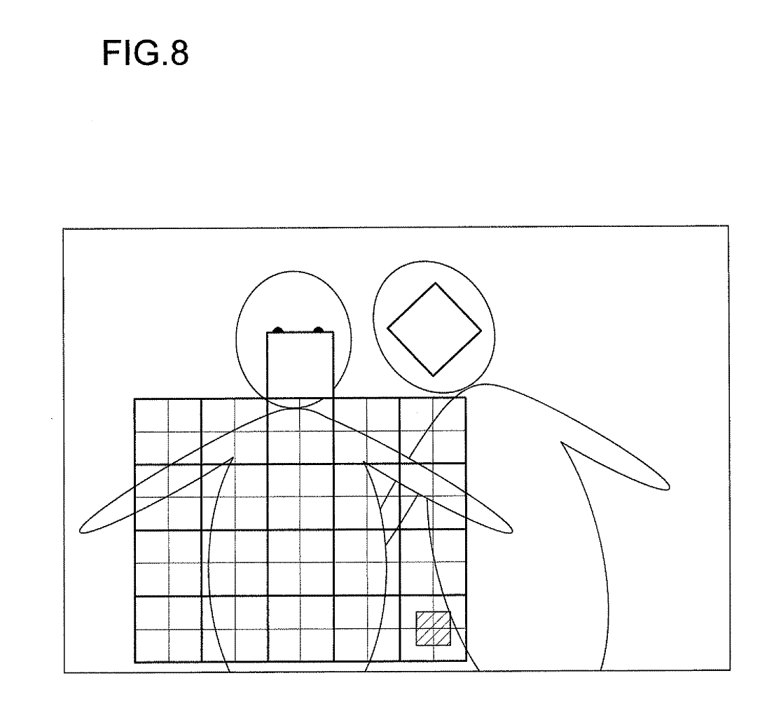

FIG. 1 is a block diagram showing the structure of the image-processing device achieved in the first embodiment. FIG. 2 presents a flowchart of the processing executed based upon the image-processing program achieved in the first embodiment. In addition, FIGS. 3 through 10 each presents an example of image processing that may be executed in the first embodiment. The first embodiment of the present invention will be described below in reference to these drawings.

An image-processing device 100 achieved in the first embodiment comprises a storage device 10 and a CPU 20. The CPU (control unit, control device) 20 includes a face detection unit 21, a human body candidate area generation unit 22, a template creation unit 23, a template-matching unit 24, a similarity calculation unit 25, a human body area estimating unit 26, and the like, all achieved in software. The CPU 20 detects an estimated human body area 50 by executing various types of processing on an image stored in the storage device 10.

Images input via an input device (not shown) are stored in the storage device 10. These images include images input via the Internet as well as images directly input from an image-capturing device such as a camera.

In step S1 in FIG. 2, the face detection unit 21 in the CPU 20 detects a human face photographed in the image based upon a face recognition algorithm and sets a rectangular block with the size depending on the areal size of the face, on the image. FIG. 3 presents examples of rectangular blocks set on an image in correspondence to the sizes of the faces. In the example presented in FIG. 3, the faces of the two people photographed in the image are detected by the face detection unit 21 which then sets rectangular blocks, e.g., square blocks, according to the sizes of the faces and the inclinations of the faces on the image. It is to be noted that the rectangular blocks set in correspondence to the sizes of the faces do not need to be square and may instead be elongated quadrangles or polygons.

It is to be noted that the face detection unit 21 detects the inclination of each face based upon the face recognition algorithm and sets a rectangular block at an angle in correspondence to the inclination of the face. In the examples presented in FIG. 3, the face of the person on the left side in the image is held almost upright (along the top/bottom direction in the image) and, accordingly, a rectangular block, assuming a size corresponding to the size of the face, is set upright. The face of the person on the right side in the image, on the other hand, is slightly tilted to the left relative to the vertical direction and, accordingly, a rectangular block assuming a size corresponding to the size of the face is set with an inclination to the left in correspondence to the tilt of the face.

Next, in step S2 in FIG. 2, the human body candidate area generation unit 22 in the CPU 20 generates a human body candidate area based upon each set of face detection results obtained through step S1. Normally, the size of the body of a given person can be estimated based upon the size of the person's face. In addition, the direction along which the body, ranging continuously from the face, is turned and the inclination of the body can be estimated based upon the tilt of the face. Accordingly, the human body candidate area generation unit 22 in the embodiment sets rectangular blocks, identical to the rectangular block for the face (See FIG. 3), having been set by the face detection unit 21 depending on the size of the face, next to one another over an image area where the body is assumed to be. It is to be noted that the rectangular blocks generated by the human body candidate area generation unit 22 only need to be substantially identical to the face rectangular block having been set by the face detection unit 21.

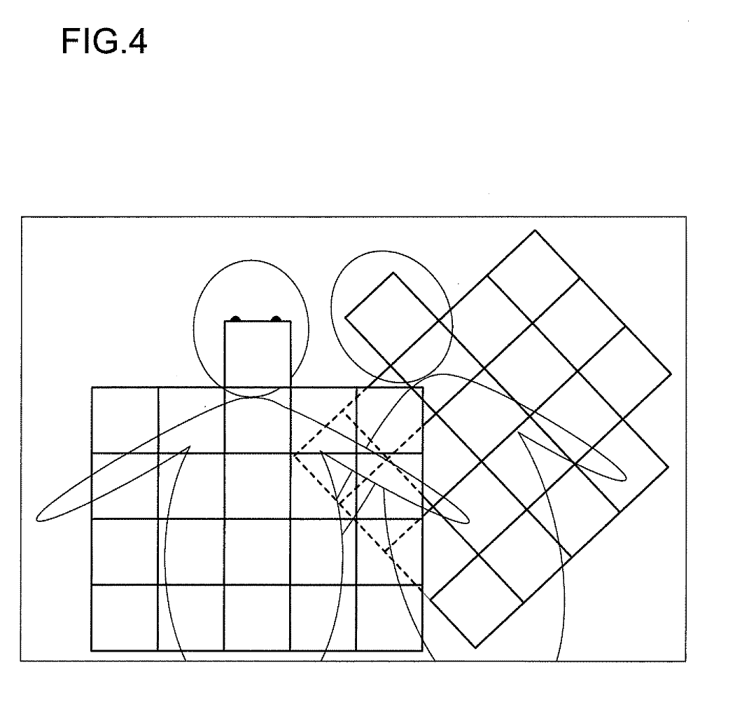

FIG. 4 presents examples of human body candidate areas, generated (set) by the human body candidate area generation unit 22 for the image shown in FIG. 3. Of the two people in the image shown in FIG. 4, the person on the left side is holding his face substantially upright and accordingly, the human body candidate area generation unit 22 estimates that his body ranges along the vertical direction under the face. The human body candidate area generation unit 22 sets a total of 20 rectangular blocks under the face of the person on the left side so that five rectangular blocks take up consecutive positions along the horizontal direction and four rectangular blocks take up consecutive positions along the vertical direction, and designates the area represented by these 20 rectangular blocks as a human body candidate area. The face of the person on the right side in the image shown in FIG. 4 is slightly tilted to the left relative to the vertical direction and the human body candidate area generation unit 22 therefore, estimates that the body, ranging continuously from the face, is slightly inclined to the left relative to the vertical direction. Accordingly, the human body candidate area generation unit 22 sets a total of 19 rectangular blocks with five rectangular blocks taking up consecutive positions along a lateral direction sloping upward to the right and four rectangular blocks taking up consecutive positions along a longitudinal direction sloping upward to the left (without the right-end rectangular block, which would not be contained in the image) so that the aggregate of the 19 rectangular blocks is tilted just as the face rectangular block is tilted, as shown in FIG. 4. The human body candidate area generation unit 22 then designates the area represented by the 19 rectangular blocks as a human body candidate area. While a specific example of image processing will be described below in reference to the human subject on the left side, image processing for the human subject on the right side will be executed in much the same way, although no illustration or description of the image processing that would be executed for the right-side human subject will be provided.

It is to be noted that the human body candidate area generation unit 22 generates a human body candidate area by setting a specific number of rectangular blocks, identical to the face rectangular block, next to one another along the longitudinal direction and the lateral direction in the example described above. As explained earlier, the probability of the body area taking up a position corresponding to the face size and orientation is high. In other words, the probability of the body area being set with accuracy is high through the human body candidate area generation method described above. However, the present invention is not limited to this example and the size and shape of the rectangular blocks set in the human body candidate area and the quantity of rectangular blocks set in the human body candidate area may be different from those set in the method described above.

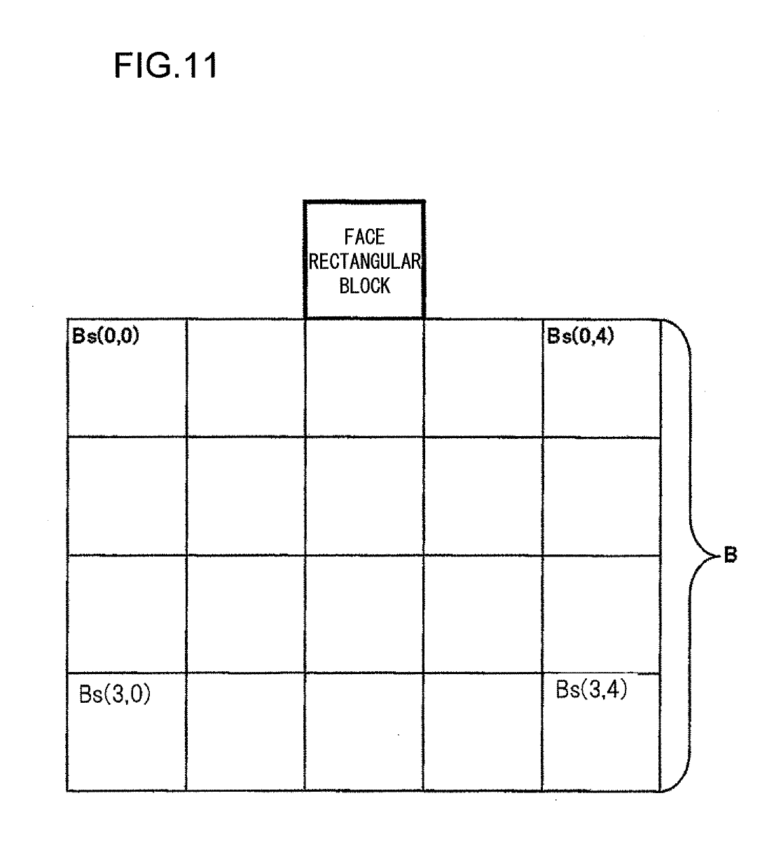

FIG. 11 shows a rectangular block set at a face position and rectangular blocks set next to one another over a human body candidate area. As FIG. 11 indicates, a human body candidate area B and each rectangular block Bs (i, j) present in the human body candidate area B can be expressed with matrices, as in (1) below, by setting specific addresses for the individual rectangular blocks Bs, namely, the rectangular block Bs (0, 0) at the upper left corner through the rectangular block Bs (3, 4) at the lower right corner. . . . (1)

Bs (i, j) in expression (1) indicates the address (row, column) of a rectangular block Bs present in the human body candidate area B whereas pix (a, b) in expression (1) indicates the address (row, column) of a pixel within each rectangular block Bs.

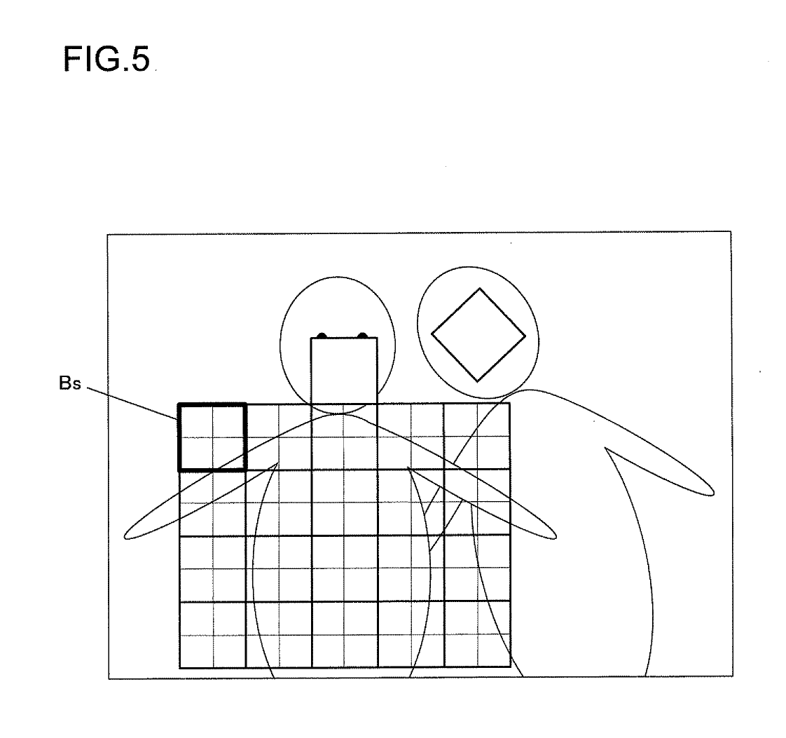

Next, the human body candidate area generation unit 22 in the CPU 20 divides each of the rectangular blocks Bs forming the human body candidate area B into four parts, as shown in FIG. 5. As a result, each rectangular block Bs is divided into four sub blocks.

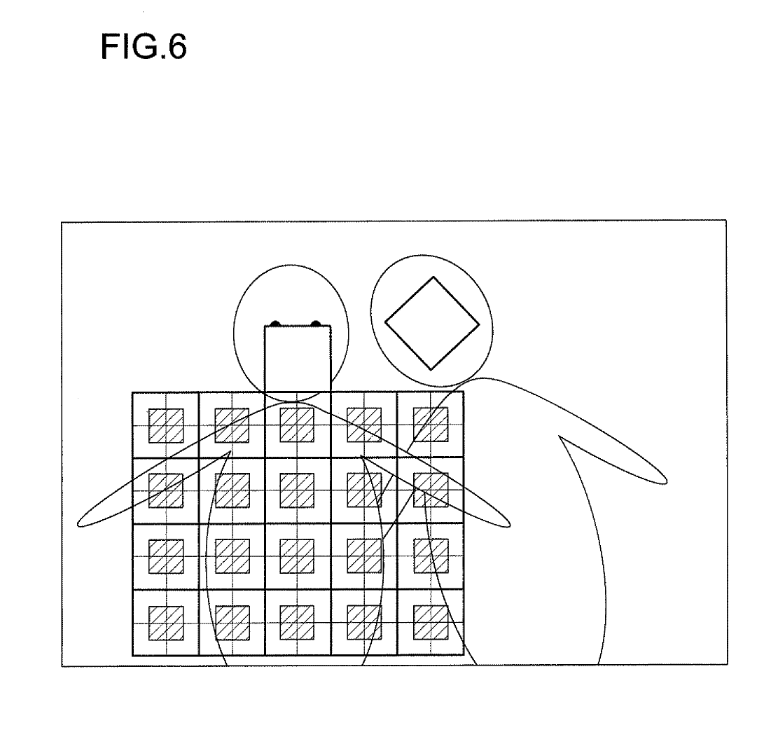

In step S3, in FIG. 2, the template creation unit 23 in the CPU 20 sets a template area, assuming a size matching that of a sub block, at the center of each rectangular block Bs, and generates a template by using the image data in the template area at the particular rectangular block Bs. The term “template” used in this context refers to a reference image that is referenced during the template matching processing to be described later. FIG. 6 shows template areas (the hatched rectangular areas at the centers of the individual rectangular blocks Bs), set by the template creation unit 23, each in correspondence to one the rectangular blocks Bs.

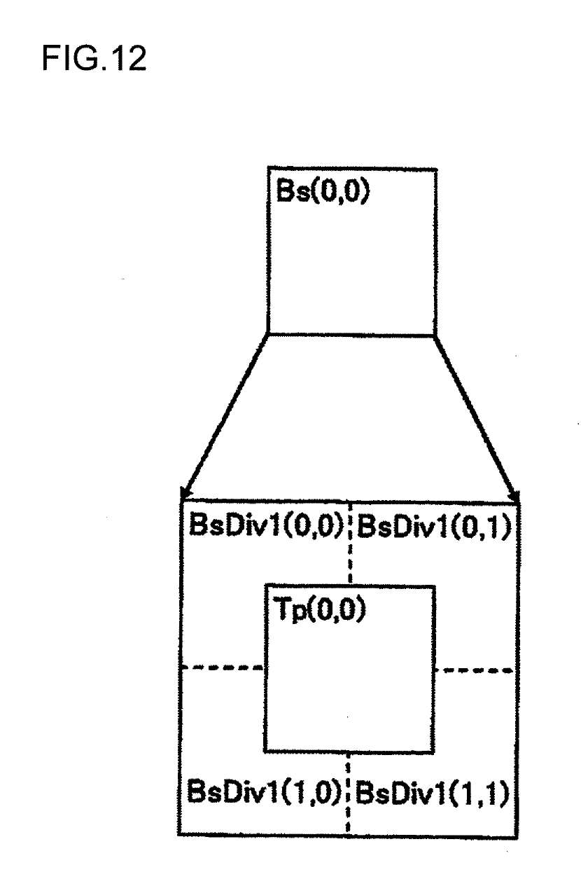

FIG. 12 shows, as an example, a template Tp (0, 0) in an enlarged view of the rectangular block Bs (0, 0) (the rectangular block at the upper left corner). The rectangular block Bs (0, 0) is divided into four sub blocks BsDiv1 (0, 0), BsDiv1 (0, 1), BsDiv1 (1, 0) and BsDiv1 (1, 1). A template area assuming a size matching that of each of the four sub blocks is set at the center of the rectangular block Bs (0, 0), and the template Tp (0, 0) is generated by using the image data in the template area.

The template can be expressed with matrices, as in (2) below. . . . (2)

T in expression (2) is a matrix of all the templates generated for the human body candidate area B and Tp (i, j) in expression (2) is a template matrix corresponding to each rectangular block Bs.

In step S4 in FIG. 2, the template-matching unit 24 in the CPU 20 obtains each template Tp (i, j) having been created by the template creation unit 23. The template-matching unit 24 then executes template-matching processing for all the sub blocks BsDiv in all the rectangular blocks Bs in reference to each of the templates Tp (i, j) having been obtained. The template-matching unit 24 in the embodiment executes the template matching processing by calculating differences in luminance (brightness) between the pixels in the template Tp and the corresponding pixels in the matching target sub block BsDiv.

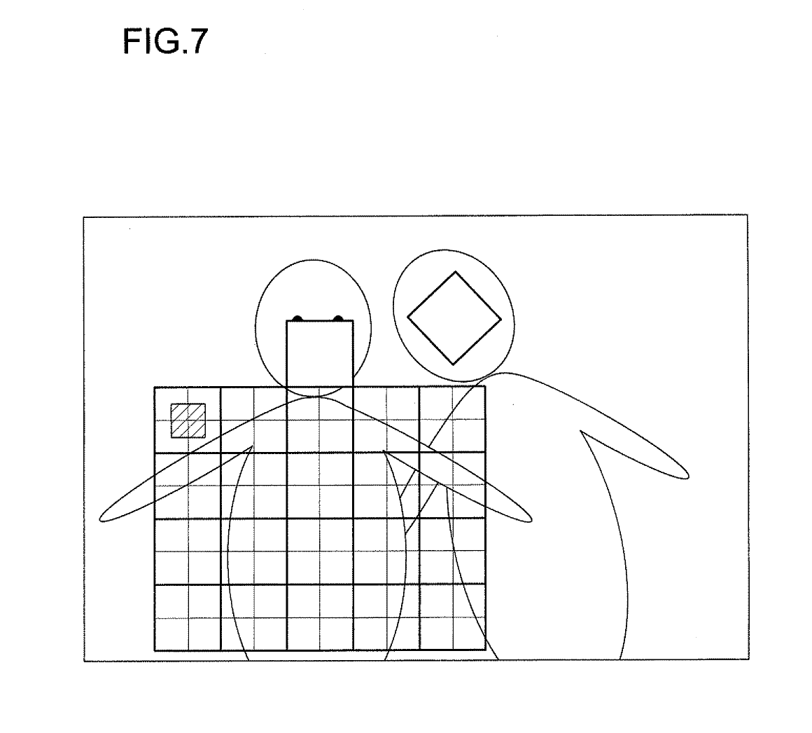

For instance, the template-matching unit 24 first executes the template-matching processing for all the sub blocks BsDiv in all the rectangular blocks Bs, in reference to the template Tp (0, 0) set at the rectangular block Bs (0, 0) at the upper left corner, as shown in FIG. 7. The template-matching unit 24 then uses the template Tp (0, 1) created at the rectangular block Bs (0, 1) and executes the template matching processing for all the sub blocks BsDiv in all the rectangular blocks Bs, in reference to the template Tp (0, 1). Subsequently, the template-matching unit 24 executes template matching for all the sub blocks BsDiv in all the rectangular blocks Bs by switching templates Tp and lastly, it executes the template-matching processing for all the sub blocks BsDiv in all the rectangular blocks 13s by using the template Tp (3, 4) created at the rectangular block Bs (3, 4) at the lower right corner.

In step S5 in FIG. 2, the similarity calculation unit 25 in the CPU 20 calculates a similarity factor (similarity level) S (m, n) through summation of the absolute values representing the differences indicated in the template-matching processing results and also calculates an average value Save for similarity factors. . . . (3)

In expression (3), M represents the total number of sub blocks present along the row direction, N represents the total number of sub blocks present along the column direction and K represents the number of templates.

Among the plurality of rectangular blocks Bs forming the human body candidate area B, a rectangular block Bs closer to the face rectangular block has a higher probability of belonging to the human body candidate area. Accordingly, the similarity calculation unit 25 applies a greater weight to the template-matching processing results for the rectangular block Bs located closer to the face rectangular block, compared to the weight applied to a rectangular block Bs located further away from the face rectangular block. This enables the CPU 20 to identify the human body candidate area with better accuracy. More specifically, the similarity calculation unit 25 calculates similarity factors S (in, n) and a similarity factor average value Save as expressed in (4) below. . . . (4)

W (i, j) in expression (4) represents a weight matrix.

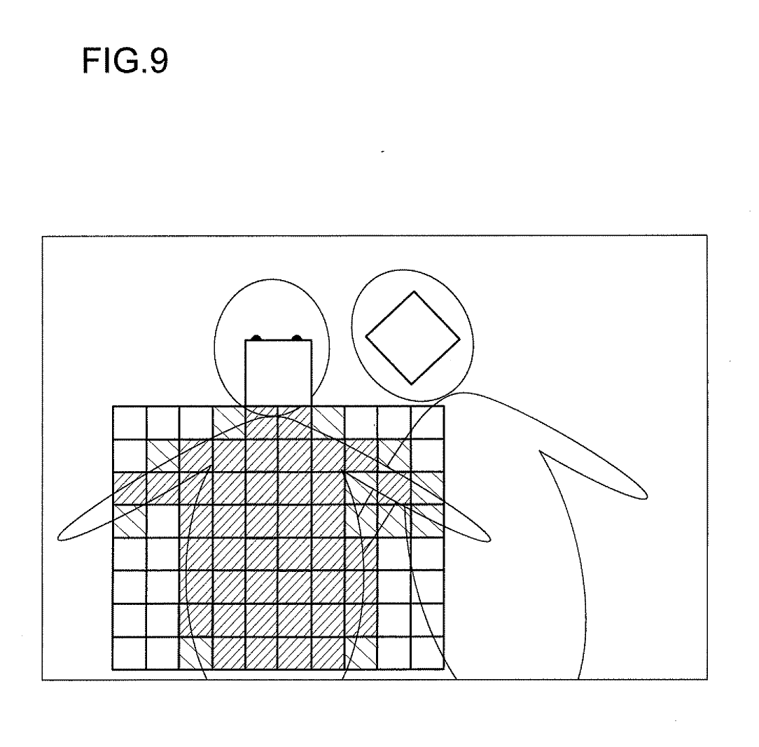

FIG. 9 shows the results of the operation executed to calculate the similarity factors S (m, n) in correspondence to all the sub blocks BsDiv in the human body candidate area B. The finely hatched sub blocks BsDiv in FIG. 9 manifest only slight differences relative to the entire human body candidate area B and thus achieve high levels of similarity.

In step S6 in FIG. 2, the human body area estimating unit 26 in the CPU 20 compares the similarity factor S (m, n) having been calculated for each sub block BsDiv with the average value Save and concludes that any sub block BsDiv with the similarity factor S (m, n) thereof represented by a value lower than the average value Save, is likely to be part of the human body area. . . . (5)

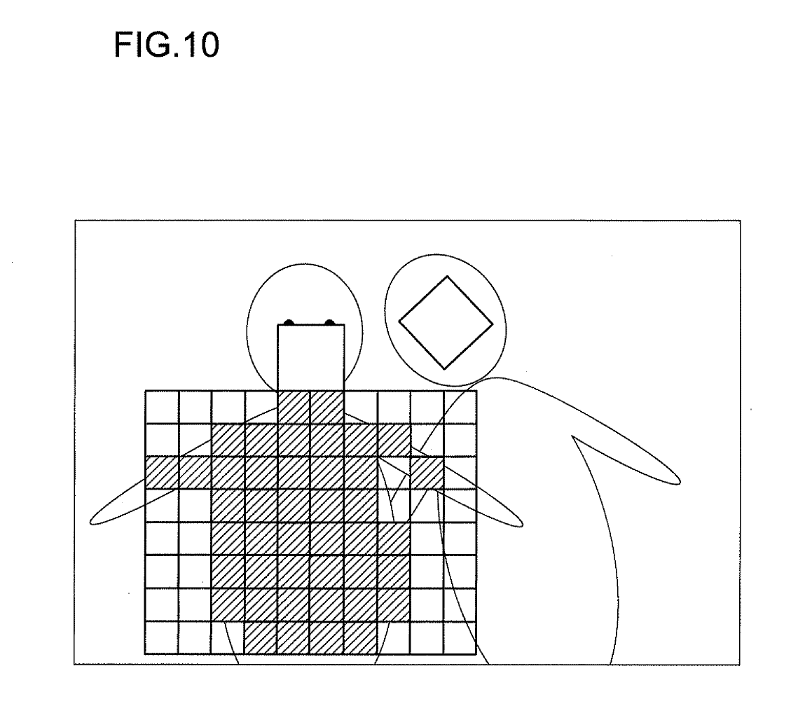

The human body area estimating unit 26 may estimate an area to be classified as a human body area by using the similarity factor average value Save as a threshold value through a probability density function or through a learning threshold discrimination method adopted in conjunction with, for instance, an SVM (support vector machine). FIG. 10 presents an example of human body area estimation results that may be obtained as described above. The hatched sub blocks BsDiv in FIG. 10 are those having been estimated to be a human body area.

### Second Embodiment of the Present Invention

In the first embodiment described above, template-matching processing is executed by comparing the value representing the luminance at each pixel in the template with the value representing the luminance at the corresponding pixel in the matching target sub block. In the second embodiment, template-matching processing is executed by comparing the frequency spectrum, the edge component, the chrominance (color difference), the hue and the like in the template with those in the matching target sub block or by comparing a combination of the frequency spectrum, the edge component, the chrominance, the hue and the like in the template with the corresponding combination in the matching target sub block, as well as by comparing the luminance values.

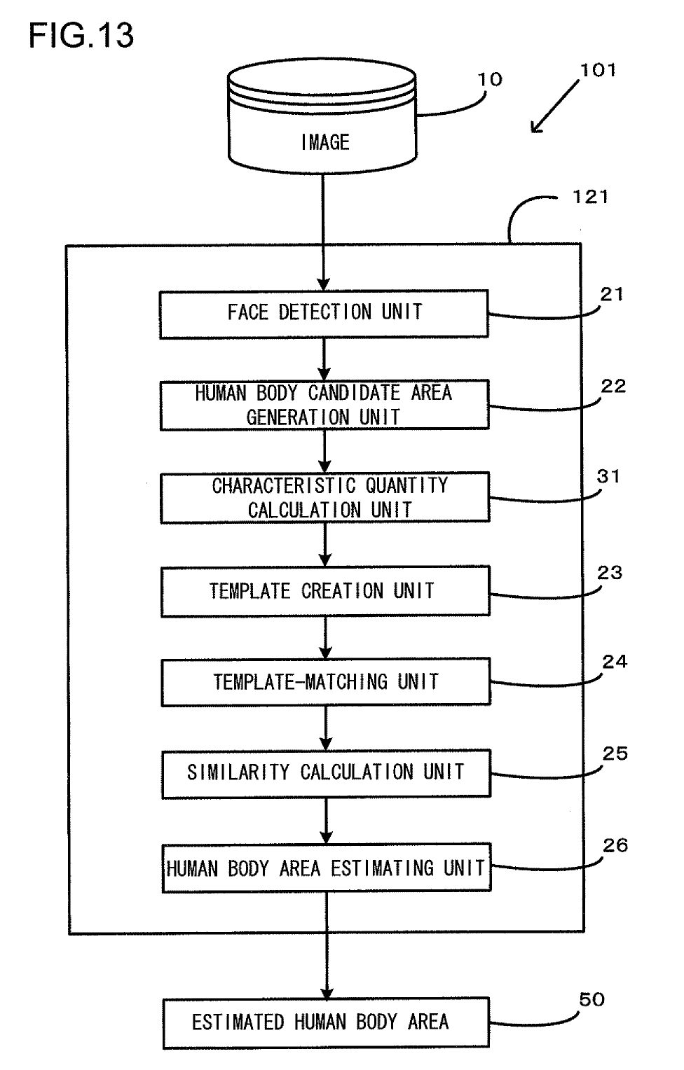

FIG. 13 is a block diagram showing the structure adopted in the second embodiment. In FIG. 13, the same reference numerals are assigned to structural components similar to those in the first embodiment described in reference to FIG. 1, and the following description will focus on distinctive features of the second embodiment. An image-processing device 101 achieved in the second embodiment comprises a storage device 10 and a CPU 121. The CPU 121 includes a characteristic quantity calculation unit 31 achieved in computer software. This characteristic quantity calculation unit 31 compares the frequency, the edge component, the chrominance, the hue and the like, as well as the luminance, in the template with those in the matching target sub block, or compares a combination of a plurality of such parameters in the template with the corresponding combination of the parameters in the matching target sub block. The characteristic quantity calculation unit 31 then executes template-matching processing by calculating the difference between data corresponding to each parameter in the template and the data corresponding to the same parameter in the matching target sub block, as described above. It is to be noted that apart from the template-matching processing executed by the characteristic quantity calculation unit 31, structural features of the second embodiment and operations executed therein are identical to the structural features and the operations of the first embodiment explained earlier, and for this reason, a repeated explanation is not provided.

### Third Embodiment of the Present Invention

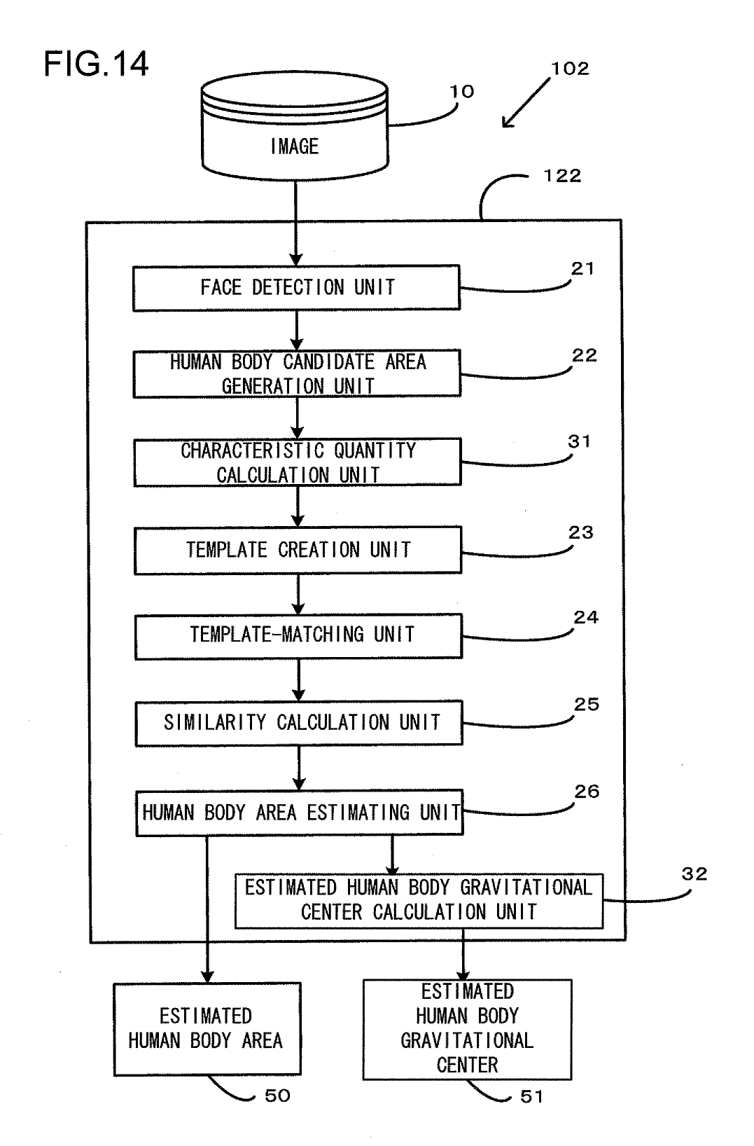

In the first embodiment described above, an area to be classified as a human body area is estimated. In the third embodiment, the gravitational center of a human body is estimated in addition to the area taken up by the human body. FIG. 14 is a block diagram showing the structure adopted in the third embodiment. In FIG. 14, the same reference numerals are assigned to structural components similar to those in the first embodiment described in reference to FIG. 1, and the following description will focus on distinctive features of the third embodiment. An image-processing device 102 achieved in the third embodiment comprises a storage device 10 and a CPU 122. The CPU 122 includes an estimated human body gravitational center calculation unit 32 achieved in computer software, which calculates the gravitational center of a human body area indicated in estimation results. The inclination of the body can be detected based upon an estimated human body gravitational center 51 thus calculated and the gravitational center of the face. It is to be noted that apart from the human body gravitational center calculation operation executed by the estimated human body gravitational center calculation unit 32, structural features and structural features of the third embodiment and operations executed therein are identical to the structural features and the operations of the first embodiment explained earlier, and for this reason, a repeated explanation is not provided.

### Fourth Embodiment of the Present Invention

In the first embodiment described earlier, a template is created by setting a template area at a central location among the sub blocks and the template thus generated is used in the template-matching processing. In the fourth embodiment, a template to be used to identify a human body area is stored in advance as training data so as to execute template-matching processing by using the training data.

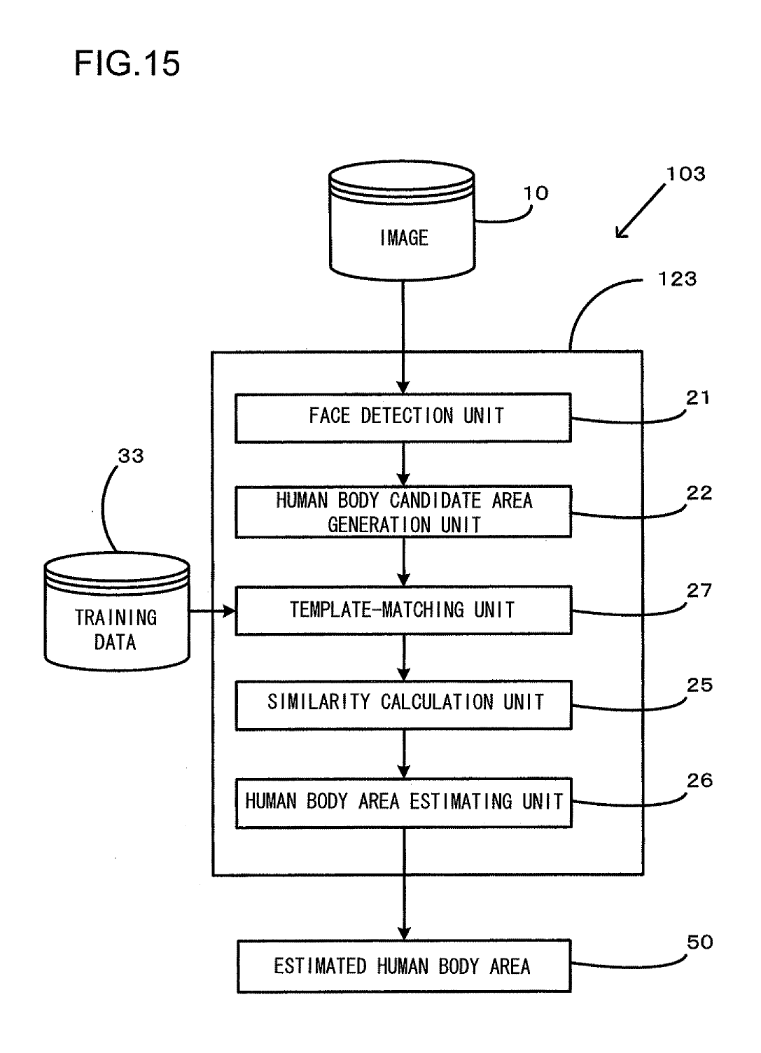

FIG. 15 is a block diagram showing the structure adopted in the fourth embodiment. In FIG. 15, the same reference numerals are assigned to structural components similar to those in the first embodiment described in reference to FIG. 1, and the following description will focus on distinctive features of the fourth embodiment. An image-processing device 103 achieved in the fourth embodiment comprises a storage device 10 and a CPU 123. A template-matching unit 27 in the CPU 123 obtains training data stored in a training data storage device 33 in advance as a template. The template-matching unit 27 then executes template-matching processing by comparing the training data with the data in each sub block. It is to be noted that apart from the template-matching processing executed by using the training data stored in the training data storage device 33, structural features of the fourth embodiment and operations executed therein are identical to the structural features and the operations of the first embodiment explained earlier and, for this reason, a repeated explanation is not provided.

In the previous embodiments described earlier, a template is created by using part of the image and thus, information used for purposes of template-based human body area estimation is limited to information contained in the image. This means that the accuracy and the detail of an estimation achieved based upon such limited information are also bound to be limited. In contrast, the image-processing device 103 in the fourth embodiment, which is able to incorporate diverse information as training data, will improve the human body area estimation accuracy and expand the estimation range. Namely, the image-processing device 103 achieved in the fourth embodiment, which is allowed to incorporate diverse information, will be able to estimate a human body area belonging to a person wearing clothing of any color or style with accuracy.

Furthermore, the range of application for the image-processing device 103 achieved in the fourth embodiment is not limited to human body area estimation. Namely, the image-processing device 103 is capable of estimating an area to be classified as an object area, e.g., an area taken up by an animal such as a dog or a cat, an automobile, a building or the like. The image-processing device 103 achieved in the fourth embodiment is thus able to estimate an area taken up by any object with high accuracy.

### Fifth Embodiment of the Present Invention

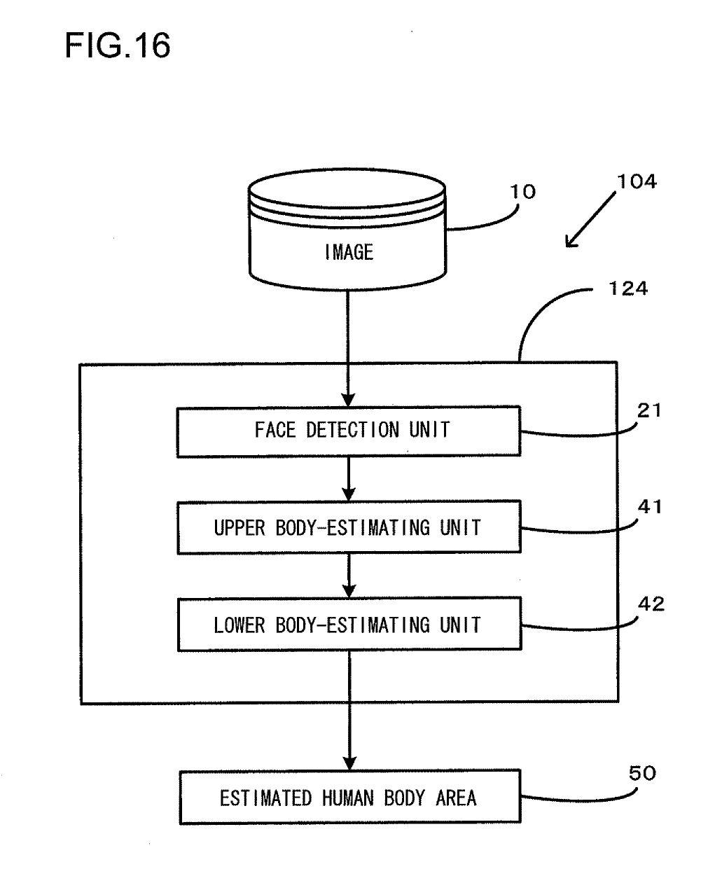

In the fifth embodiment, an upper body area is estimated based upon face detection results and then a lower body area is estimated based upon the estimated upper body area indicated in the estimation results. FIG. 16 is a block diagram showing the structure adopted in the fifth embodiment. In FIG. 16, the same reference numerals are assigned to structural components similar to those in the first embodiment described in reference to FIG. 1, and the following description will focus on distinctive features of the fifth embodiment.

FIG. 16 is a block diagram showing the overall structure of an image-processing device 104 achieved in the fifth embodiment. The image-processing device 104 in the fifth embodiment comprises a storage device 10 and a CPU 124. The CPU 124, which includes a face detection unit 21, an upper body-estimating unit 41 and a lower body-estimating unit 42 achieved in computer software, estimates an area to be classified as a human body area.

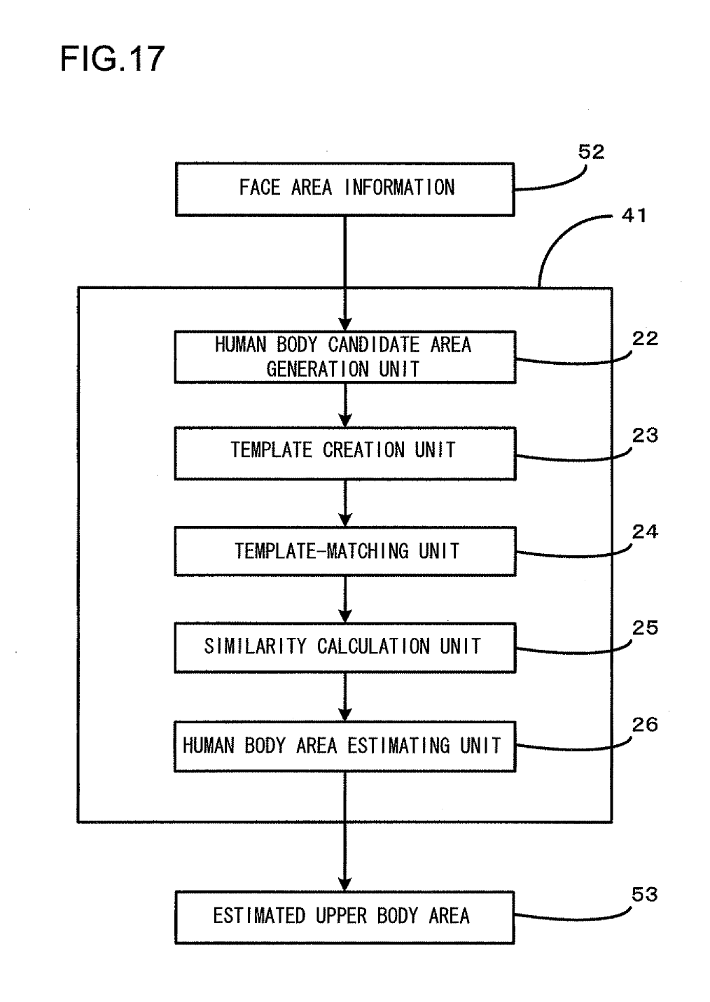

FIG. 17 is a block diagram showing the structure of the upper body-estimating unit 41. The upper body-estimating unit 41, which comprises a human body candidate area generation unit 22, a template creation unit 23, a template-matching unit 24, a similarity calculation unit 25 and a human body area estimating unit 26 achieved in computer software, estimates an area corresponding to the upper half of a human body based upon face area information 52 provided by the face detection unit 21 and outputs an estimated upper body area 53.

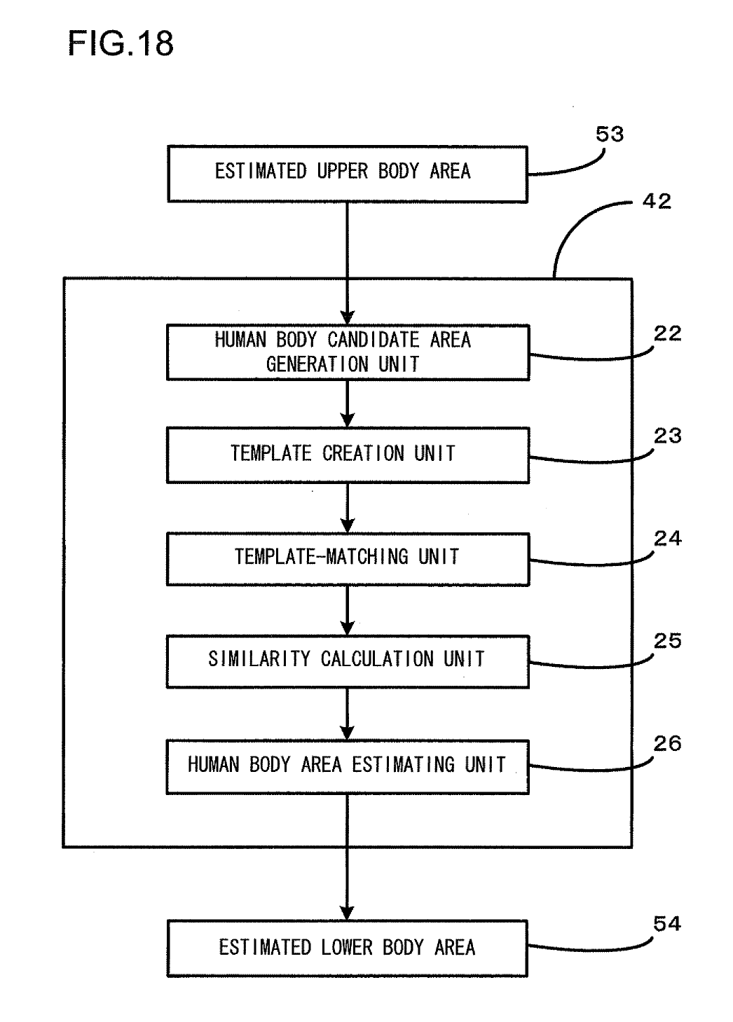

FIG. 18 is a block diagram showing the structure of the lower body-estimating unit 42. The lower body-estimating unit 42, which comprises the human body candidate area generation unit 22, the template creation unit 23, the template-matching unit 24, the similarity calculation unit 25 and the human body area estimating unit 26 achieved in computer software, estimates an area corresponding to the lower half of the human body based upon the estimated upper body area 53, having been estimated by the upper body-estimating unit 41, and outputs an estimated lower body area 54.

In the fifth embodiment described above, a human body area is estimated by using the upper body area estimation results for purposes of lower body area estimation, so as to assure a high level of accuracy in the estimation of the overall human body area.

It is to be noted that if a human body area cannot be detected through the processing executed based upon the image-processing program achieved in any of the embodiments described above, the CPU may execute the processing again by modifying or expanding the human body candidate area.

While an explanation has been given in reference to the embodiments on an example in which the face area detection unit 21 detects a human face in an image and an area taken up by the body in the image is estimated based upon the face detection results, the application range for the image-processing device according to the present invention is not limited to human body area estimation. Rather, the image-processing device according to the present invention may be adopted for purposes of estimating an object area such as an area taken up by an animal, e.g., a dog or a cat, an area taken up by an automobile, an area taken up by a building structure, or the like. An animal with its body parts connected via joints, in particular, moves with complex patterns and, for this reason, detection of its body area or its attitude has been considered difficult in the related art. However, the image-processing device according to the present invention detects the face of an animal in an image and estimates the animal body area in the image with a high level of accuracy based upon the face detection results. Namely, the image-processing device according to the present invention can accurately estimate the human body area taken up by the body of a person, i.e., an animal belonging to the primate hominid group, with his ability to make particularly complex movements through articulation of the joints in his limbs, and is further capable of detecting the attitude of the body and the gravitational center of the body based upon the human body area estimation results as well.

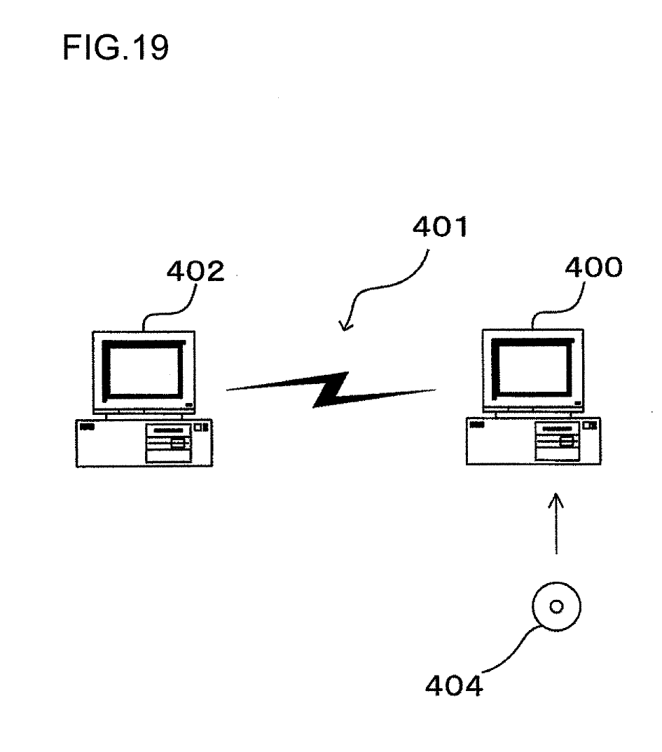

While the present invention is realized in the form of an image-processing device in the embodiments and variations thereof described above, the image processing explained earlier may be executed on a typical personal computer by installing and executing an image-processing program enabling the image processing according to the present invention in the personal computer. It is to be noted that the image-processing program according to the present invention may be recorded in a recording medium such as a CD-ROM and provided via the recording medium, or it may be downloaded via the Internet. As an alternative, the image-processing device or the image-processing program according to the present invention may be mounted or installed in a digital camera or a video camera so as to execute the image processing described earlier on a captured image. FIG. 19 shows such embodiments. A personal computer 400 takes in the program via a CD-ROM 404. The personal computer 400 also has a capability for connecting with a communication line 401. A computer 402 is a server computer at which the program, stored in a recording medium such as a hard disk 403, is available. The communication line 401 may be a communication line used for Internet communication, personal computer communication or the like, or it may be a dedicated communication line. The computer 402 reads out the program from the hard disk 403 and transmits the program to the personal computer 400 via the communication line 401. Namely, the program may be provided as a computer-readable computer program product assuming any of various modes such as data communication (carrier wave).

It is to be noted that the embodiments described above and the variations thereof may be adopted in any conceivable combination, including a combination of different embodiments and the combination of an embodiment and a variation.

The following advantages are achieved through the embodiments and variations thereof described above. Namely, the face of an animal in an image is first detected by the face detection unit 21 and then, based upon the face detection results, the human body candidate area generation unit 22 sets a body candidate area (rectangular blocks) likely to be taken up by the body of the animal (human) in the image. The template-matching units 24 and 27 obtain a reference image (template) respectively via the template creation unit 23 and the training data storage device 33. The human body candidate area generation unit 22 divides each rectangular block in the animal body candidate area into a plurality of sub areas (sub blocks). The template-matching units 24 and 27, working together with the similarity calculation unit 25, determine, through arithmetic operation, the level of similarity manifesting between the image in each of the plurality of sub areas and the reference image. Then, based upon the similarity factors thus calculated, each in correspondence to one of the plurality of sub areas, the human body area estimating unit 26 estimates an area contained in the animal body candidate area, which should correspond to the animal's body. Through these measures, the image-processing device is able to accurately detect the area taken up by the body of the animal.

In addition, in the embodiments and variations thereof described above, the human body candidate area generation unit 22 sets a candidate area for an animal's body in an image in correspondence to the size of the animal's face and the tilt of the animal's face, as shown in FIG. 4. The probability for the animal body area to take up the position corresponding to the face size and the tilt of the face is high. Thus, the image-processing device, which assures a high probability for setting the body candidate area exactly at the area of the actual body, is able to improve the body area estimation accuracy.

In the embodiments and the variations thereof described above, the face detection unit 21 sets a rectangular block depending on the size of the face of an animal and the tilt of the face, at the position taken up by the animal's face in the image. Then, the human body candidate area generation unit 22 sets an animal body candidate area by setting a specific number of rectangular blocks each identical to the face rectangular block, next to one another, as shown in FIG. 4. The animal body area has a high probability of assuming a position and size corresponding to the size and tilt of the face. Thus, the image-processing device, which assures a high probability for setting the body candidate area exactly at the area of the actual body, is able to improve the body area estimation accuracy.

In the embodiments and the variations thereof described above, the human body candidate area generation unit 22 defines sub areas (sub blocks) by dividing each of the plurality of rectangular blocks forming the animal body candidate area into a plurality of small areas. As a result, the image-processing device is able to determine levels of similarity, based upon which the body area is estimated, with high accuracy.

In the embodiments and the variations thereof described above, the template creation unit 23 sets a template area, assuming a size matching that of a sub block, at the center of each rectangular block and creates a template by using the image in the template area. As a result, the image-processing device is able to determine levels of similarity, based upon which the body area is estimated, with high accuracy.

In the embodiments and variations thereof described above, the similarity calculation unit 25 applies a greater weight to the similarity factor calculated for a sub block within the candidate area located closer to the animal's face. This allows the image-processing device to estimate the animal body area with high accuracy.

In the embodiments and variations thereof described above, the CPU calculates a similarity factor by comparing values indicated in the target sub block image and in the template, in correspondence to a single parameter among the luminance, the frequency, the edge component, the chrominance and the hue or corresponding to a plurality of such parameters. As a result, the image-processing device is able to determine levels of similarity, based upon which the body area is estimated, with high accuracy.

In the fourth embodiment and the variation thereof described above, the template-matching unit 27 uses an image stored in advance in the training data storage device 33 as a template, instead of images extracted from the sub blocks. This means that the image-processing device is able to estimate the body area by incorporating diverse information without being restricted to information contained in the image. As a result, the image-processing device is able to assure better accuracy for human body area estimation and, furthermore, is able to expand the range of estimation.

In the fifth embodiment and the variation thereof, the upper body-estimating unit 41 estimates an area corresponding to the upper half of a person's body. Then, the lower body-estimating unit 42 estimates an area corresponding to the lower half of the person's body based upon the upper body area estimation results. As a result, the image-processing device is able to estimate the area corresponding to the entire body with high accuracy.

In the embodiments and variations thereof, the template-matching unit 24 or 27 executes template-matching processing by using a template constituted with the image in a template area or training data. However, the present invention is not limited to these examples and the image-processing device may designate the image in each sub block set by the human body candidate area generation unit 22 as a template or may designate an image contained in an area in each rectangular block, which assumes a size matching the size of a sub block, as a template.

It is to be noted that the embodiments and variations thereof described above simply represent examples and the present invention is in no way limited to the particulars of these examples. Any other mode conceivable within the range of the technical teachings of the present invention should, therefore, be considered to be within the scope of the present invention.

The disclosure of the following priority application is herein incorporated by reference:

Japanese Patent Application No. 2011-047525 filed Mar. 4, 2011

1. An image-processing device, comprising:
a face detection unit that detects a face of an animal in an image;
a candidate area setting unit that sets an animal body candidate area for a body of the animal in the image based upon face detection results provided by the face detection unit;
a reference image acquisition unit that obtains a reference image;
a similarity calculation unit that divides the animal body candidate area having been set by the candidate area setting unit into a plurality of small areas and calculates a level of similarity between an image in each of the plurality of small areas and the reference image; and
a body area estimating unit that estimates an animal body area corresponding to the body of the animal from the animal body candidate area based upon levels of similarity having been calculated for the plurality of small areas by the similarity calculation unit.

2. An image-processing device according to claim 1, wherein:
the candidate area setting unit sets the animal body candidate area in the image in correspondence to a size and a tilt of the face of the animal having been detected by the face detection unit.

3. An image-processing device according to claim 1, wherein:
the face detection unit sets a rectangular frame depending on a size and a tilt of the face of the animal at a position of the face of the animal in the image; and
the candidate area setting unit sets the animal body candidate area by placing a specific number of rectangular frames, each identical to the rectangular frame having been set by the face detection unit, next to one another.

4. An image-processing device according to claim 3, wherein:
the similarity calculation unit defines the plurality of small areas by dividing each of the plurality of rectangular frames that forms the animal body candidate area into a plurality of areas.

5. An image-processing device according to claim 4, wherein:
the reference image acquisition unit further sets second small areas each contained within one of the rectangular frames and having a size matching a size of one of the plurality of small areas, and obtains images in a plurality of second small areas so as to use each image as the reference image; and
the similarity calculation unit calculates levels of similarity between images in the individual small areas and the image in each of the plurality of second small areas.

6. An image-processing device according to claim 5, wherein:
the reference image acquisition unit sets each of the second small areas at a center of one of the rectangular frame.

7. An image-processing device according to claim 1, wherein:
the similarity calculation unit applies a greater weight to a level of similarity calculated for a small area, among the plurality of small areas set within the animal body candidate area, which is closer to the face of the animal having been detected by the face detection unit.

8. An image-processing device according to claim 1, wherein:
the similarity calculation unit calculates levels of similarity by comparing one of or a plurality of parameters among luminance, frequency, edge component, chrominance and hue between the images in the small areas and the reference image.

9. An image-processing device according to claim 1, wherein:
the reference image acquisition unit uses an image stored in advance as the reference image.

10. An image-processing device according to claim 1, wherein:
the face detection unit detects a face of a person in an image as the face of the animal;
the candidate area setting unit sets a human body candidate area for a body of the person in the image as the animal body candidate area based upon the face detection results provided by the face detection unit;
the similarity calculation unit divides the human body candidate area having been set by the candidate area setting unit into a plurality of small areas and calculates levels of similarity between images in the plurality of small areas and the reference image; and
the body area estimating unit estimates a body area corresponding to the body of the person, which is included in the human body candidate area, as the animal body area based upon the levels of similarity having been calculated for the plurality of small areas by the similarity calculation unit.

11. An image-processing device according to claim 10, wherein:
an upper body area corresponding to an upper half of the body of the person is estimated and then a lower body area corresponding to a lower half of the body of the person is estimated based upon estimation results obtained by estimating the upper body area.

12. An image-processing device, comprising:
a face detection unit that detects a face of an animal in an image;
a candidate area setting unit that sets a candidate area for a body of the animal in the image based upon face detection results provided by the face detection unit;
a similarity calculation unit that sets a plurality of reference areas within the candidate area for the body having been set by the candidate area setting unit and calculates levels of similarity between images within small areas defined within the candidate area and a reference image contained in each of the reference areas; and
a body area estimating unit that estimates an animal body area corresponding to a body of the animal, which is included in the candidate area for the body, based upon the levels of similarity calculated for the small areas by the similarity calculation unit.

13. A computer-readable computer program product containing an image-processing program that enables a computer to execute;
face detection processing for detecting a face of an animal in an image;
candidate area setting processing for setting an animal body candidate area for a body of the animal in the image based upon face detection results obtained through the face detection processing;
reference image acquisition processing for obtaining a reference image;
similarity calculation processing for dividing the animal body candidate area, having been set through the candidate area setting processing, into a plurality of small areas and calculating levels of similarity between images in the plurality of small areas and the reference image; and
body area estimation processing for estimating an animal body area corresponding to a body of the animal, which is included in the animal body candidate area, based upon the levels of similarity having been calculated through the similarity calculation processing for the plurality of small areas.
